(19) United States
(12) Patent Application Publication
(10) Pub. No.: US 2002/0187349 A1
(43) Pub. Date: Dec. 12, 2002

(54) Diamond-like carbon coating for optical media molds

(76) Inventors: J. Hans Richter, Lancaster, PA (US); Val L. Lieberman, Lancaster, PA (US); Yasuo Yamazaki, Lancaster, PA (US)

Correspondence Address: Martin Fruitman, 419 N. George St., Millersville, PA, 17551, US

(21) Appl. No.: 09/877,451

(22) Filed: Jun. 11, 2001

(51) Int. Cl. B32B 9/00

(52) U.S. Cl. 428/408; 428/457

(57) ABSTRACT

The disclosure is for an improved film coating useable on optical media molds and the apparatus for and method of making such a film. The film is a diamond-like carbon layer of 0.3 to 3.0 microns coated on a titanium underlayer of 0.1 to 1.0 microns. The method of making the diamond-like carbon film is to deposit a defect free underlayer coating on to the steel substrate of the mold using an electron beam coating apparatus that has a hollow cathode electron beam generator and a rotating crucible containing the coating material. The diamond-like carbon film is then produced on top of the underlayer coating.

### BACKGROUND OF THE INVENTION

This invention deals generally with the coating of metals and more specifically with a diamond-like carbon film on metal or ceramic substrates with improved adhesion and the apparatus and method for producing such a film.

Perhaps the oldest method of depositing diamond-like carbon films is by breaking down hydrocarbon gases in the plasma of a radio frequency discharge. There are many references on this subject and some go back as much as 20 or 30 years. The term used to identify this method is radio frequency chemical vapor deposition, and the coatings it produces are commonly referred to as a:C—H coatings because of the presence of hydrogen in the film along with carbon. Such diamond-like carbon films are amorphous, meaning that they do not have long range repeatability of atomic orientation in their crystalline structure. These films are used for a variety of applications ranging from scratch resistant coatings on optical lenses to coatings on razor blades.

However, diamond-like carbon films have poor adhesion when deposited on most metal substrates. One method of improving adhesion of the film to the substrate, particularly a steel substrate, is to deposit a thin layer of some other metal on the substrate before applying the diamond-like carbon film. This layer, which is called the underlayer, relieves the stresses in the diamond-like carbon film and prevents delamination. U.S. Pat. No. 5,827,613 by Nakayama et al discloses depositing a molybdenum underlayer by means of ion bombardment of a molybdenum grid in the vicinity of the substrate being coated.

In the prior art the most common method of depositing the underlayer is sputtering. There are commercially available diamond-like carbon coating systems that utilize sputtering techniques to produce the underlayer. These sputtering systems work adequately for depositing the underlayer on the majority of two dimensional substrates where the coating is deposited onto a relatively flat surface, but depositing the underlayer on three dimensional parts by sputtering is often complicated and sometimes impossible.

One reason is that the deposition rate drops dramatically as the distance increases between the target, the source of the material being sputtered, and the substrate. This results in thinner and more porous films on surfaces even slightly offset from the nearest surface of the substrate. For three dimensional substrates that means some surfaces will have compromised underlayer thickness and quality.

The sputtering process is also characterized as a line of sight process, in which deposition occurs almost exclusively on those areas which can optically “see” the target. This limitation makes it difficult to sputter film onto complicated shapes such as concave or convex surfaces or holes. The productivity of the process also suffers since there is a limiting distance between the cathode and the substrate.

Another problem with sputtered films is their inherent porosity which becomes a problem when producing optical quality surface finishes, referred to as zero-finish. The porosity of the underlayer results in a “hazy” appearance of the diamond-like carbon top coat, which is totally unacceptable in the optical disc molding industry.

Since the underlayer is an integral part of a diamond-like carbon film, the limitations of the sputtering process described above restrict the use of diamond-like carbon films. It would be very beneficial to have a method of producing a metallic underlayer for diamond-like carbon films on three dimensional substrates and an underlayer which was free of haze.

### SUMMARY OF THE INVENTION

The present invention avoids the limitations of the prior art methods of producing the metallic underlayer for a diamond-like carbon film by using a hollow cathode method and apparatus for depositing a physical vapor deposition (PVD) coating which can be used independently or as an underlayer for a diamond-like carbon coating. The hollow cathode method uses a watercooled crucible acting as an anode and a hollow tube made of refractory metal acting as a cathode. The coating material is then placed in the crucible and an electron beam is generated between the hollow cathode and the crucible. The electron beam melts the coating material and vapor is therefore generated. The vapor is ionized by the electron beam with the aid of an injected inert gas, and the ions and neutral atoms migrate to the substrate that may also have a negative voltage relative to the chamber wall.

This method which can be used to deposit individual coatings of materials such as titanium nitride, titanium carbo-nitride, and the like and also metallic underlayers for diamond-like carbon coatings has a far better ability to propagate a coating than does the sputtering technique. The difference is related to the way the vapor is generated and its vapor pressure. The hollow cathode method generates vapor with a higher partial pressure than does sputtering, and higher vapor pressure results in higher mobility of atoms yielding better coverage of three dimensional substrates and complicated shapes. The hollow cathode method produces very dense film with a surface finish that is as good as the original finish on the substrate. This eliminates problems with haze.

Although the hollow cathode technology produces high quality, dense films, it has an inherent drawback that limits its application for depositing optical quality films onto compact disc molds. The problem is that conventional hollow cathode deposition methods produce splashes of molten metal which adhere to the surface of the treated parts and solidify. The size of such splashes may reach tens or even hundreds of microns, whereas the film thickness is only a few microns. Such splashes protrude from the underlayer appearing like mountains under a microscope, and they are poorly adhered to the rest of the underlayer. Any diamond-like carbon film deposited on top of a splash would repeat the shape of the splash and create a protrusion in the final film. High accuracy optical products such as optical media molds and optical lens molds require surface finishes for which imperfections are frequently measured in fractions of a microns, and splash defects are not acceptable for such molds.

The present invention avoids splashes by rotating the crucible and placing the hollow cathode so that the vertical axes of the hollow cathode and the crucible are offset from each other. This geometry allows the electron beam generated by the hollow cathode to be directed to an area offset from the center of the crucible. Thus, the rotation of the crucible and the offset point of impact of the electron beam produce continuous movement of the location of the pool of melted material within the crucible. This action eliminates the creation of gas pockets which are the cause of the splashes that occur when films are produced without the present invention's offset beam and rotation of the crucible. The apparatus and method of the present invention thereby produces coatings and a diamond-like carbon film which are superior to any produced by the prior art, and which are completely satisfactory for surfaces on optical quality molds.

### BRIEF DESCRIPTION OF THE DRAWINGS

FIG. 1 is a schematic diagram of the apparatus of the invention.

FIG. 2 is an enlarged cross section view of the region of the invention including the hollow cathode and the rotating crucible.

### DETAILED DESCRIPTION OF THE INVENTION

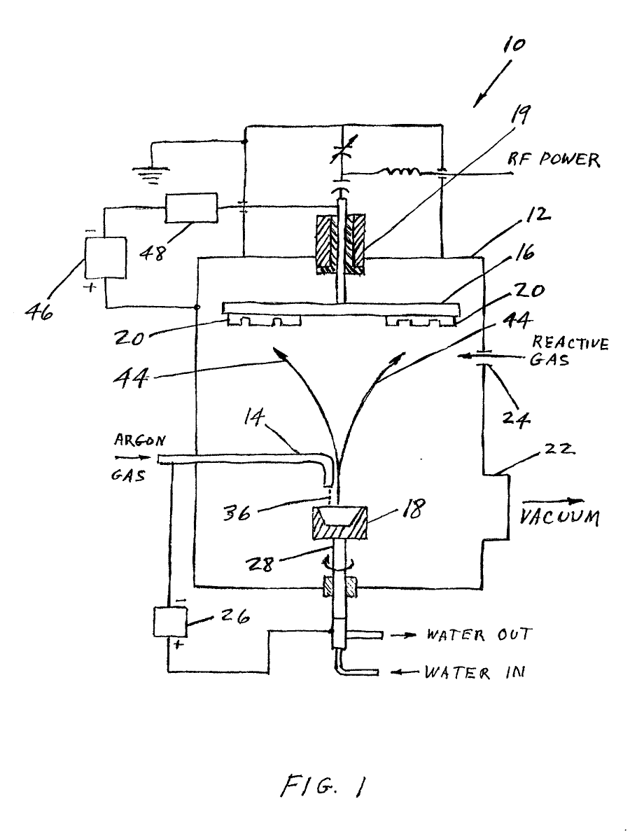

FIG. 1 is a schematic diagram of coating apparatus 10 of the invention in which vacuum chamber 12 contains hollow cathode 14, substrate holder 16, and crucible 18. Substrate 20 is held onto substrate holder 16 by conventional means such as mechanical clamping as substrate holder 16 is rotated. Radio frequency power is applied to substrate holder 16 by conventional means (not shown) through feedthrough 19. The radio frequency is used to produce the diamond-like carbon top layer after the underlayer is coated onto the substrate.

Vacuum chamber 12 is maintained at a suitable level of vacuum in the range of 1×10⁻² to 1×10⁻⁵ Torr by vacuum port 22 which is connected to a vacuum system (not shown), and as in all such diamond-like carbon coating processes, a reactive gas such as acetylene is fed into vacuum chamber 12 at pipe 24.

Inert gas argon is supplied to vacuum chamber 12 through hollow cathode 14. Hollow cathode 14 is maintained at a negative voltage of 20 to 100 volts relative to rotating crucible 18 by power supply 26, and substrate holder 16 is maintained at a negative voltage relative to vacuum chamber 12 by power supply 46 which is connected to substrate holder 16 through radio frequency filter 48. The DC voltage applied to substrate holder 16 is used for increasing the density of the underlayer and is not required for all applications.

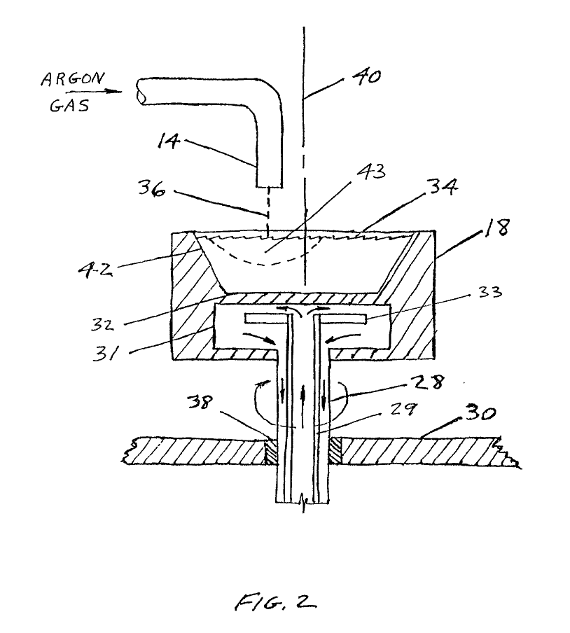

FIG. 2 is an enlarged cross section view of the region of the coating apparatus adjacent to rotating crucible 18 which is rotated by shaft 28 that passes through vacuum chamber wall 30. Crucible 18 has a central cavity 32 which contains coating material 34. The preferred coating material 34 for use as an underlayer for a diamond-like carbon film is titanium, which is placed in cavity 32 in the form of pellets and melted by the power supplied from electron beam 36 which is generated between hollow cathode 14 and crucible 18. However, the same apparatus can be used to deposit not only the underlayer, but also bulk coatings such as titanium nitride and the like.

Crucible 18 itself is water cooled by using shaft 28 to transport water to and from the crucible. As shown in FIG. 2, shaft 28 is hollow and has input pipe 29 located at its center. The return water path is in the annular space between input pipe 29 and the inner wall of hollow shaft 28. Cooling cavity 31 within crucible 18 includes separator 33 to direct the cooling water against the walls of cooling cavity 31. Water is furnished to and removed from hollow shaft 28 by a conventional rotating coupling (not shown).

The benefit of the invention is attained by the rotation of crucible 18 and the offset orientation of hollow cathode 14 relative to axis of rotation 40 of crucible 18. Crucible 18 is rotated by means of shaft 28 which is interconnected with a motor (not shown) external to vacuum chamber 12. Shaft 28 passes through wall 30 of vacuum chamber 12 at sealed bearing 38.

As in all such hollow cathode systems, the electron beam melts the coating material in the crucible and forms liquid metal pool 43, and metal vapor is therefore generated. Vapor 44 is also ionized by the electron beam as an inert gas, argon, is fed into the hollow cathode to maintain the ionization. The ions and neutral atoms migrate to substrate 20, and when the ions and neutral atoms contact the substrate they form the desired coating. The ions and neutral atoms are actually deposited upon the substrate because the substrate is at a lower temperature than the liquid metal pool so that the metal vapor essentially condenses on the substrate.

With the offset orientation, the electron beam created between hollow cathode 14 and crucible 18, which acts as an anode, is directed to target material 34 at a location between axis 40 and sidewall 42 of cavity 32. As crucible 18 rotates, the location at which electron beam 36 is directed creates liquid pool 43 within metal 34 in crucible cavity 32, and the constantly changing location of liquid metal pool 43 prevents gas bubbles that would otherwise cause splashing. The criteria for the successful prevention of gas bubbles is that liquid pool 43 extends across axis 40 of crucible 18 and does not touch sidewall 42 of cavity 32. The speed of rotation of crucible 18 must also be controlled to fall within the range between 1/20 and 3 revolutions per minute.

When these specifications are met, the present invention prevents the splashing which results in imperfections in the coating deposited on the substrate.

A film of diamond-like carbon can then be formed on top of the substrate coating when a hydrocarbon reactive gas such as acetylene is injected into vacuum chamber 12 at port 24 while radio frequency power is applied to substrate 20. The resulting film has the required optical quality for compact disc molds because there are no splashes formed in the underlayer on the substrate.

Thus, the method for producing the coating of the present invention is as follows:

placing a substrate to be coated on a rotating substrate holder within a vacuum chamber;

placing a material to be coated onto the substrate within a crucible rotating around an axis of rotation within the vacuum chamber;

locating a hollow cathode with an axis within the vacuum chamber with the hollow cathode oriented so that the hollow cathode axis intersects the material within the crucible at a location offset from the axis of rotation of the crucible;

producing a vacuum within the vacuum chamber;

generating an electron beam between the hollow cathode and the material within the crucible to create a pool of melted material and to produce vapor of the material by feeding an inert gas into the hollow cathode and into the region of the electron beam to create ions to sustain the electron beam, and by applying a DC voltage between the cathode and the crucible;

optionally, applying negative voltage to the substrate holder and substrate respectively; and

maintaining the substrate at a temperature below the temperature of the melted material so that the material vapor deposits upon the substrate.

Similarly, the method for producing the diamond-like carbon coating of the present invention on an optical media mold is as follows:

placing a substrate to be coated on a rotating substrate holder within a vacuum chamber;

placing a metal to be coated onto the substrate within a crucible rotating around an axis of rotation within the vacuum chamber;

locating a hollow cathode with an axis within the vacuum chamber with the hollow cathode oriented so that the hollow cathode axis intersects the metal within the crucible at a location offset from the axis of rotation of the crucible;

producing a vacuum within the vacuum chamber;

generating an electron beam between the hollow cathode and the metal within the crucible to create a pool of melted metal and to produce vapor of the metal by feeding an inert gas into the hollow cathode and into the region of the electron beam to create ions to sustain the electron beam, and by applying a DC voltage between the cathode and the crucible;

optionally, applying negative voltage to the substrate holder and substrate respectively;

maintaining the substrate at a temperature below the temperature of the melted metal so that the metal vapor deposits upon the substrate as an underlayer;

stopping the depositing of the underlayer on the substrate;

supplying radio frequency power to the substrate; and

feeding a reactive gas into the vacuum chamber after the underlayer is produced to form a diamond-like carbon film on top of the underlayer.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

For example, although titanium is the preferred metal for the underlayer for a diamond-like carbon film, other metals can also be used.

What is claimed as new and for which Letters Patent of the United States are desired to be secured is:

1. A method of producing a coating on a substrate comprising:
placing a substrate to be coated on a rotating substrate holder within a vacuum chamber;
placing a material to be coated onto the substrate into a crucible rotating around an axis of rotation within the vacuum chamber;
locating a hollow cathode with an axis within the vacuum chamber with the hollow cathode oriented so that the hollow cathode axis intersects the material within the crucible at a location offset from the axis of rotation of the crucible;
producing a vacuum within the vacuum chamber;
generating an electron beam between the hollow cathode and the material within the crucible to create a pool of melted material and to produce vapor of the material by feeding an inert gas into the hollow cathode and into the region of the electron beam to create ions to sustain the electron beam, and by applying a DC voltage between the cathode and the crucible; and
maintaining the substrate at a temperature below the temperature of the melted material so that the material vapor deposits a coating upon the substrate.

2. The method of claim 1 further including maintaining the pool of melted material at a size and location so that the pool extends across the axis of rotation of the crucible but does not contact the side of the crucible.

3. A method of producing a diamond-like carbon film on a metal substrate comprising:
placing a substrate to be coated on a rotating substrate holder within a vacuum chamber;
placing a metal to be coated onto the substrate into a crucible rotating around an axis of rotation within the vacuum chamber;
locating a hollow cathode with an axis within the vacuum chamber with the hollow cathode oriented so that the hollow cathode axis intersects the metal within the crucible at a location offset from the axis of rotation of the crucible;
producing a vacuum within the vacuum chamber;
generating an electron beam between the hollow cathode and the metal to within the crucible to create a pool of melted metal and to produce vapor of the metal by feeding an inert gas into the hollow cathode and into the region of the electron beam to create ions to sustain the electron beam, and by applying a DC voltage between the cathode and the crucible;
maintaining the substrate at a temperature below the temperature of the melted metal so that the metal vapor deposits upon the substrate as an underlayer;
stopping the depositing of the underlayer on the substrate;
supplying radio frequency power to the substrate; and
feeding a reactive gas into the vacuum chamber after the underlayer is produced to form a diamond-like carbon film on top of the underlayer.

4. The method of claim 3 further including maintaining the pool of melted metal at a size and location so that the pool extends across the axis of rotation of the crucible but does not contact the side of the crucible.

5. An apparatus for creating a film on a substrate comprising:
a vacuum chamber in which a vacuum can be created;
a rotating substrate holder within the vacuum chamber with a drive shaft penetrating a wall of the vacuum chamber;
a substrate attached to the substrate holder;
a crucible rotating on an axis of rotation, with a drive shaft for the crucible penetrating a wall of the vacuum chamber and a cavity within the crucible holding a metal to be coated upon the substrate;
a first D.C. power supply with its positive output terminal interconnected with the rotating crucible; and
a hollow cathode penetrating a wall of the vacuum chamber through which an inert gas is fed into the vacuum chamber, with the hollow cathode interconnected with the negative output terminal of the first power supply so that an electron beam can be generated between the hollow cathode and the crucible, with the hollow cathode having an axis which determines the direction of the electron beam and the axis of the hollow cathode intersecting the material within the crucible at a location offset from the axis of rotation of the crucible.

6. The apparatus of claim 5 further including a means for feeding a reactive gas into the vacuum chamber and a means for applying radio frequency power to the substrate holder.

7. The apparatus of claim 5 further including a second D.C. power supply with its positive output terminal connected to the vacuum chamber and its negative output terminal connected to the substrate holder.

8. A diamond-like carbon coating on a metal substrate comprising a metal underlayer produced by the use of an electron beam generated between a hollow cathode and a rotating crucible, and a diamond-like carbon film formed on top of the underlayer.

9. A coating on a substrate produced by the use of an electron beam generated between a hollow cathode and a crucible rotating on an axis of rotation, with coating material located within the crucible and vaporized by the electron beam, with the electron beam impacting the coating material at a location offset from the axis of rotation of the crucible.
